(19) United States
(12) Patent Application Publication
(10) Pub. No.: US 2006/0146812 A1
(43) Pub. Date: Jul. 6, 2006

(54) Methods and systems for routing data using a destination server

(75) Inventors: Bradford H. Farr, Lexington, KY (US); Samuel L. Rhodus, Danville, KY (US); William T. Warner III, Lexington, KY (US); Kenneth R. Wilkerson, Lexington, KY (US); Timothy G. Yorkey, Lexington, KY (US); Joel S. Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/026,581

(22) Filed: Dec. 30, 2004

(51) Int. Cl. H04L 12/28; H04L 12/56

(52) U.S. Cl. 370/389; 370/392

(57) ABSTRACT

A system for routing data over a network. The system can include a destination device having an address, an origination device, and a destination server. The origination device can be configured to generate a routing application request including a recipient identifier, to transmit the routing application request to a destination server, to receive a routing application from the destination server, and to automatically execute the routing application. The destination server can be configured to create the routing application based on the address of the destination device and preferential formats for routing data to a recipient with the destination device, to receive the routing application request from the origination device, and to transmit the routing application to the origination device.

### BACKGROUND OF THE INVENTION

Embodiments of the invention relate to methods and systems for routing data without requiring a sender to know specific routing information. In particular, embodiments of the invention relate to methods and systems for routing data using a destination server.

In some previous implementations of routing systems, a sender who is routing data to a recipient is required to know specific information about how the data will be routed to the recipient. For example, a sender must know an “address” of a recipient. The address of a recipient can include an electronic mail (“e-mail”) address, a phone number, a network address of a printer, a network address of a memory device, or a postal mailing address.

When a sender is required to know specific routing information for a recipient (e.g., an address), the sender must be alerted to changes to the routing information for a recipient. If a sender is unaware of changes to the routing information, the sender may route data to an address that is no longer associated with the intended recipient. Typically, routing information changes must be propagated to all possible senders or posted at a central location (e.g., a phone book, e-mail directory, etc.) that is accessible to all possible senders.

### SUMMARY OF THE INVENTION

Due to the difficulty and effort needed to alert all possible senders of routing information changes, recipients typically are not able to change their routing information as often as they may like.

Accordingly, embodiments of the invention provide a system for routing data over a network. The system can include a destination device having an address, an origination device, and a destination server. The origination device can be configured to generate a routing application request including a recipient identifier identifying a recipient of the data, to transmit the routing application request to a destination server, to receive a routing application from the destination server, and to automatically execute the routing application to route the data to the recipient by transmitting the data to the destination device. The destination server can be configured to create the routing application based on the address of the destination device and preferential formats for routing data to the recipient with the destination device, to receive the routing application request from the origination device, and to transmit the routing application to the origination device.

The system can include a destination device having an address. The system can also include an origination device configured to generate a routing application request including a recipient identifier identifying a recipient of the data, to transmit the routing application request to a destination server, to receive a routing application from the destination server, and to automatically execute the routing application to route the data to the recipient. The destination server can be configured to receive and store the address of the destination device and preferential formats for routing data to the recipient with the destination device, to receive the routing application request from the origination device, to create the routing application, and to transmit the routing application to the origination device. The routing application may contain the address of the destination device and the preferential formats.

Additional embodiments provide a method of routing data over a network. The method can include selecting data to be routed with an origination device; selecting a recipient identifier, the recipient identifier identifying a recipient of the data; and generating a routing application request including the recipient identifier. The method can also include transmitting the routing application request to a destination server, retrieving a routing application from the destination server, and transmitting a routing application to the origination device from the destination server, wherein the routing application is associated with the recipient identifier. The method can further include executing the routing application with the origination device to route the data to the recipient.

Another embodiment provides a method of operating a destination server. The method can include associating an address of a destination device with a recipient identifier, the recipient identifier identifying a recipient; specifying preferential formats for routing data to the recipient with the destination device; and transmitting the recipient identifier, the address, and the preferential formats to the destination server. The method can also include generating a routing application associated with the recipient identifier based on the address and the preferential formats, storing the routing application in the destination server, and transmitting the routing application from the destination server to an origination device upon receiving a routing application request including the recipient identifier from the origination device.

Yet another embodiment provides a destination server. The destination server can include an input/output module configured to receive a routing application request including a recipient identifier from an origination device, to transmit a routing application to the origination device, and to receive an address of a destination device and preferential formats for routing data to a recipient identified by the recipient identifier with the destination device. The destination server can also include a memory module configured to store the routing application and a processor configured to generate the routing application based on the address and the preferential formats and to retrieve the routing application from the memory module upon receiving the routing application request from the origination device.

Yet another embodiment provides a destination server. The destination server can include an input/output module configured to receive a routing application request including data and a recipient identifier from an origination device. The input/output module may also be configured to receive an address of a destination device and preferential formats for routing data to the recipient with the destination device and to transmit the data to the destination device. The destination server can also include a memory module configured to store a routing application and a processor configured to generate the routing application based on the address and the preferential formats and to execute the routing application to route the data to the recipient.

Some other embodiments provide a destination server interface application executable with an origination device to route data over a network. The application can be configured to obtain a recipient identifier, to generate a routing application request, to transmit the routing application request to a destination server, to receive a routing application from the destination server, and to cause the routing application to be executed.

Further embodiments provide a destination server interface application. The application can be configured to obtain an address of a destination device and preferential formats for routing data to a recipient identified by a recipient identifier with the destination device and to transmit the recipient identifier, the address, and the preferential formats to a destination server.

Furtherstill, some embodiments provide a computer-readable medium including instructions for operating a destination server. The computer-readable medium can include instructions for associating an address of a destination device with a recipient identifier; specifying preferential formats for routing data to the recipient with the destination device; and transmitting the recipient identifier, the address, and the preferential formats to the destination server. The computer-readable medium can also include instructions for generating a routing application associated with the recipient identifier based on the address and the preferential formats, storing the routing application in the destination server, and transmitting the routing application to an origination device upon receiving a routing application request including the recipient identifier.

Other features and advantages of embodiments of the invention will become apparent to those skilled in the art upon review of the following detailed description and drawings.

### BRIEF DESCRIPTION OF THE DRAWINGS

In the drawings, wherein like reference numerals indicate like parts:

FIG. 1 illustrates an exemplary data routing system including an origination device, a destination server, and multiple destination devices.

FIG. 2 illustrates another exemplary data routing system including an origination device, a destination sever, and a destination device.

FIG. 3 is a schematic diagram of exemplary hardware inside the origination device, the destination server, and one of the multiple destination devices of FIG. 1.

FIG. 4 illustrates an exemplary format of routing information transmitted to a destination server.

FIG. 5 is a diagram of non-volatile memory, which can be part of the memory module of the origination device illustrated in FIG. 3, illustrating that a portion of the non-volatile memory can be used to store a destination server interface application.

FIG. 6 is a flow chart illustrating an exemplary process of operating a destination server to generate a routing application.

FIG. 7 is a flow chart illustrating an exemplary process of routing data from an origination device to a destination device.

FIG. 8 illustrates another exemplary data routing system including an origination device, a first destination server, a second destination server, and multiple destination devices.

FIG. 9 illustrates another exemplary data routing system including an origination device, a destination server, and multiple destination devices.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

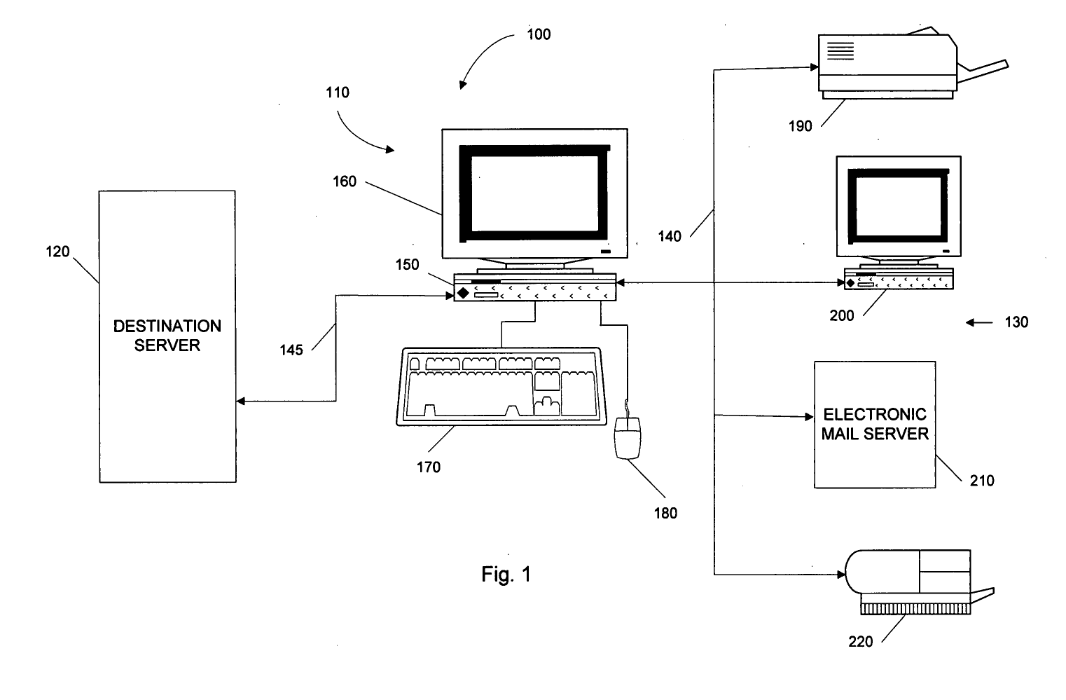

FIG. 1 illustrates an exemplary data routing system 100. The system 100 includes an origination device 110, a destination server 120, and one or more destination devices 130. The origination device 110 and the destination devices 130 can be connected to each other with a network or connection 140. The origination device 110 is connected to the destination server 120 with a connection 145. The connections 140 and 145 can include a wired connection and/or a wireless connection as well as local area network (“LAN”) connections and wide area network (“WAN”) connections. In some embodiments, the connection 140 and the connection 145 are part of the same network or connection, such as a LAN or the Internet.

In some embodiments, as illustrated in FIG. 1, the origination device 110 includes a workstation 150. The workstation 150 can include one or more input/output devices such as a monitor or display 160, a keyboard 170, and a cursor control device 180, which is shown in the form of a mouse. A sender or user can use the workstation 150 and the input/output devices (e.g., the monitor 160, the keyboard 170, and the cursor control device 180) to select and route data to a recipient. It should be understood that the origination device 110 can include other components in addition to or in place of the workstation 150.

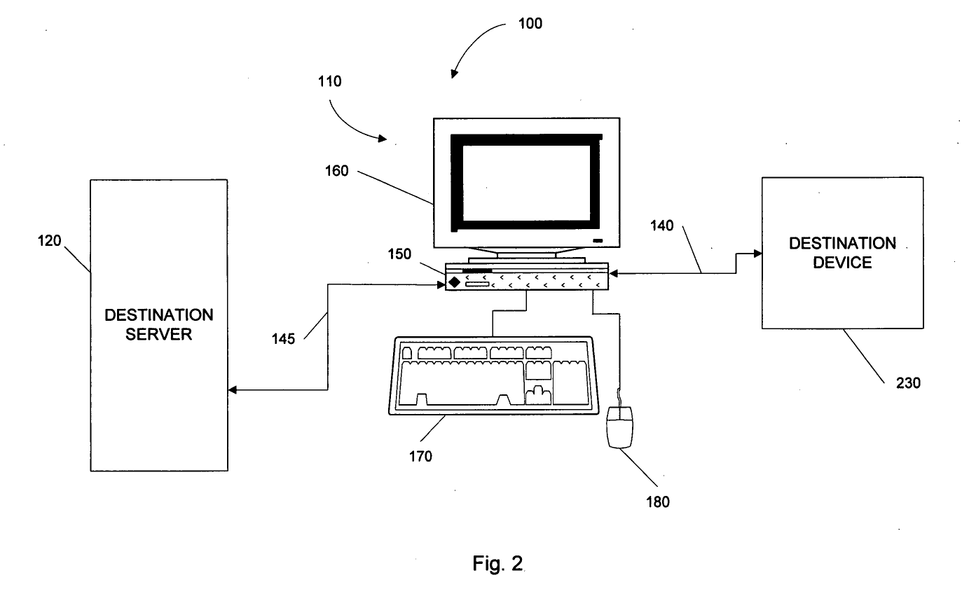

The one or more destination devices 130 can be configured to receive data transmitted from the origination device 110 and to provide the data to a recipient. In some embodiments, the destination devices 130 can represent mechanisms for providing the data to a recipient. A recipient can include a specific individual, a group of specific individuals, or an individual or group of individuals at a specific location. For example, a recipient can be a person (for example, “John Doe”) or the receptionist at the front desk of company, for example, Company XYZ. A recipient can also include a specific location such as the receiving office of Company XYZ. As illustrated in FIG. 1, the destination devices 130 can include a printing device 190, a workstation 200, an electronic mail (“e-mail”) server 210, and/or a facsimile device 220. Each destination device 130 is addressed such that data can be routed on the connection 140 and arrive at one or more of the destination devices 130. Each address can be unique such that data can be routed to a specific destination device 130. One or more destination devices 130 can also be associated with a broadcast or group address. Data routed to a group address can be routed to multiple destination devices 130. It should be understood that the destination devices 130 illustrated in FIG. 1 are exemplary and should not be construed as limiting or required. The destination devices 130 can also include a telephone, a pager, a database or archiving system, a multi-function device, or any other device configured to receive input from the origination device. It should also be understood that multiple destination devices 130 are not required. As illustrated in FIG. 2, the origination device 110 can be connected to a single destination device 230.

In some embodiments, the destination server 120 includes an application server (not shown). The application server can be configured to provide executable applications to the origination device 110 over the connection 145. Rather than storing executable applications on the origination device 110 where they need to be replaced whenever an application is modified, the application server can act as a central repository for applications. The origination device 110 can request an application from the application server when needed, and the application server can transmit the requested application to the origination device 110. Upon receiving the requested application, the origination device 110 executes the application, and the next time the application is needed, the origination device 110 requests another copy of the application to ensure that it has the most recently updated version. In some embodiments, the origination device 110 is only required to know an interface to the application such that the origination device 110 can execute the application. The application server encapsulates the details of the application and the modifications made to the application.

As should also be apparent, the system 100 can include multiple origination devices, destination devices, destination servers, and other devices not shown. In some embodiments, the system 100 can include routers, switches, or network connections that allow components of the system 100 to communicate with each other.

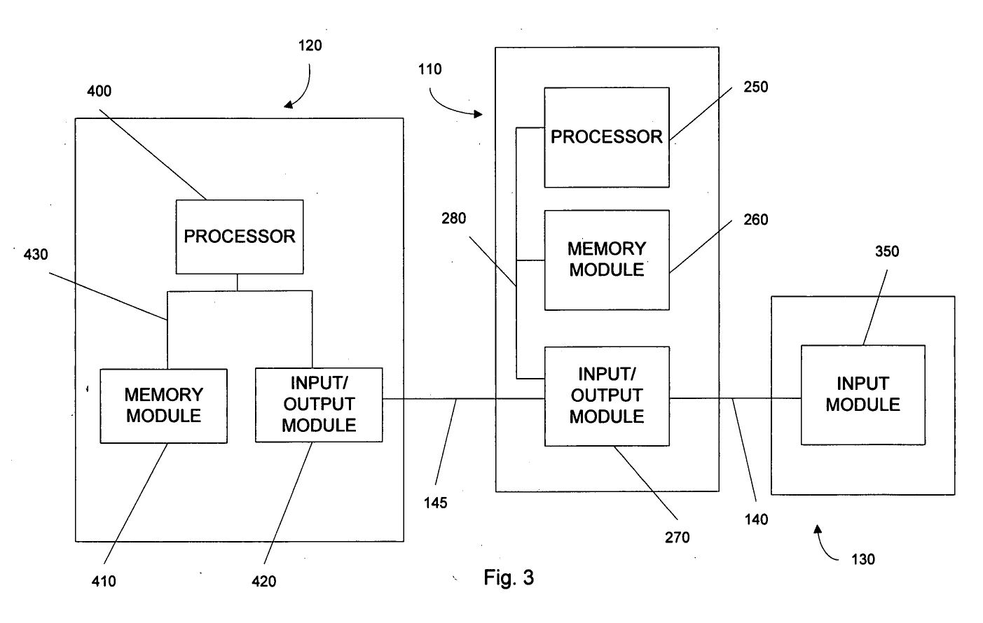

FIG. 3 illustrates exemplary hardware that can be included in the origination device 110, the destination server 120, and one of the destination devices 130. As illustrated in FIG. 3, the origination device 110 includes a processor 250, a memory module 260, and an input/output module 270. The processor 250, the memory module 260, and the input/output module 270 can be connected with a connection or bus 280.

The processor 250 of the origination device 110 (as well as the processor 400 (described below)) can include a microprocessor, a macroprocessor, an application specific integrated circuit (“ASIC”), or a combination thereof. In some embodiments, the processor 250 can be configured to fetch instructions and/or data from the memory module 260 via the bus 280 and execute the instructions to process the data. The memory module 260 can include non-volatile memory such as one or more forms of ROM, one or more disk drives, RAM, other memory, or combinations of the foregoing.

The processor 250 can be configured to obtain data and a recipient identifier associated with the data. The processor 250 can be further configured to transmit the data and the recipient identifier to the input/output module 270 on the bus 280. The input/output module 270 can transmit the recipient identifier to the destination server 120 via the connection 145. In some embodiments, in response to transmitting the recipient identifier, the input/output module 270 can also receive a routing application from the destination server. The processor 250 can be configured to execute the routing application. Executing the routing application with the processor 250 can cause the input/output module 270 to transmit the data to one of the destination devices 130 via the connection 140. Executing the routing application transmitted from the destination server 120 can also cause the processor 250 to process the data before routing it to a recipient. As discussed in detail below, before transmitting the data to the input/output module 270 for routing, the processor 250 may process the data by encrypting the data or formatting the data for a specific destination device 130. The processor 250 may also electrically sign the data to supply sender verification. The processor 250 can also transmit processing instructions to the input/output module 270, such that the processing instructions are routed to one of the destination devices 130 along with the data. Furthermore, the processor 250 may transmit a confirmation application to be executed by one of the destination devices 130 to provide a transmission confirmation to the sender of the data. In some embodiments, the input/output module 270 may also transmit the data and/or the recipient identifier via the connection 145 to the destination server 120.

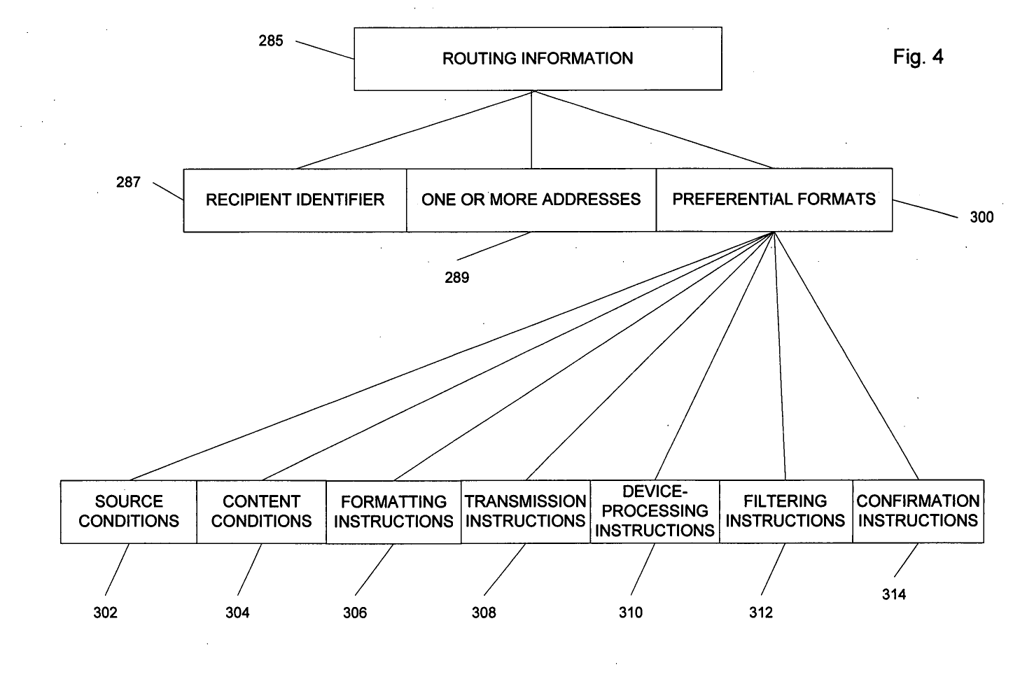

The processor 250 can also be configured to obtain and transmit routing information to the input/output module 270 on the bus 280. The input/output module 270 can then transmit the routing information to the destination server 120 on the connection 145. FIG. 4 illustrates an exemplary format for routing information 285. In some embodiments, the routing information 285 can include a recipient identifier 287 that identifies a possible recipient of data. The routing information can also include one or more addresses 289 of destination devices 130 associated with the recipient identifier. The one or more addresses can indicate where data that is sent to the possible recipient of data should be routed. For example, the routing information 285 can include the address of the printing device 190 indicating that data sent to the recipient should be sent to the printing device 190.

The routing information 285 can further include preferential formats 300 that specify conditions and options for routing data to the recipient. For example, the preferential formats 300 can include source conditions 302 that specify conditions for routing data to the one or more addresses 289 depending on the source or sender of the data. For example, the source conditions 302 can specify that data sent to the recipient from all sources should be routed to one of the one or more addresses 289. The source conditions 302 can also specify that only data sent from a specific source (e.g., a sender operating the origination device or an address of the origination device, etc.) should be routed to one of the one or more addresses 289. For example, the source conditions 302 can specify that all data sent from John Doe to the recipient should be routed to the e-mail server 210 and all data from a particular origination device should be routed to the facsimile device 220.

In some embodiments, the preferential formats 300 can include content conditions 304. The content conditions 304 can specify how data is to be routed based upon the content of the data. For example, forms routed to a recipient could be routed to different destination devices 130 depending on the fields of the forms. Content conditions 304 can specify fields that identify a particular type of form and can specify specific destinations for different types of forms. The content conditions 304 can also specify routing based on values contained in the fields. For example, fields with numeric values that fall within particular ranges, fields with string values that include a specific substring or string characteristics, and fields with images with particular image characteristics (e.g., image resolution, image color, image graphic representation, etc.) can all be routed to one of the one or more addresses as specified with the content conditions 304.

If data is sent in audio format, the content conditions 304 can also specify routing instructions for the data based on the type of sounds the data represents. For example, data containing sounds classified as “music” can be routed to one destination device 130 and data containing sounds classified as “voice” can be routed to a different destination device 130. In some embodiments, data sent in audio format can also be routed based on whether the audio format matches a particular format (e.g., a particular voice, sound, pitch, key, etc.).

The content conditions 304 can also specify how to route data that is encrypted and/or compressed. For example, any encrypted and/or compressed data may be routed to a particular destination device 130 configured to process secure data. The preferential formats 300 can also specify how and when to decrypt encrypted data or decompress compressed data (described below). In general, any identifying characteristics of the data being sent could be specified in the content conditions 304 and used to determine how to route the data.

In some embodiments, the preferential formats 300 can specify formatting instructions 306. The formatting instructions 306 can specify how to format the sent data such that it can be routed to a particular destination device 130. For example, data sent from an e-mail application may not be acceptable to the printing device 190. The formatting instructions 306 can specify how to translate the data sent from the e-mail application to a format recognizable by the printing device 190. The formatting instructions 306 can specify translation instructions directly or can specify an application or driver executable with the origination device 110 and/or one of the destination devices 130 that can be operated to format the data.

The formatting instructions 306 can also include instructions for alerting a recipient or user of a destination device 130 of formatting that should be performed manually with the destination device 130. For example, rather than transmitting decryption instructions to the destination device 130, the origination device 110 can transmit instructions for displaying a message or alerting a user of the destination device 130 that the user must execute a particular decryption application to decrypt the encrypted data.

Furthermore, the preferential formats 300 can specify transmission instructions 308. The transmission instructions 308 can specify how the data is to be transmitted to a destination device 130. For example, the transmission instructions 308 can specify a network or path for the data to be transmitted over. The transmission instructions 308 can also specify whether and when the data should be encrypted. The transmission instructions 308 can specify that all data sent to a recipient should be encrypted. In some embodiments, the transmission instructions 308 can also specify that only data sent from a particular sender or containing particular content should be encrypted. The transmission instructions 308 can also specify how the data is to be encrypted and can specify an encryption algorithm and/or encryption keys. In some embodiments, the transmission instructions 308 may specify a public encryption key used in an asymmetric encryption scheme and the recipient or the destination device 130 provides the corresponding private decryption key.

The transmission instructions 308 can also specify whether and when data should be compressed. The transmission instructions 308 can also specify that only data sent from a particular sender or containing particular content should be compressed. The transmission instructions 308 can further specify a compression algorithm to use to compress the data.

As additional security, the transmission instructions 308 can also specify whether sender verification is required. Sender verification can be obtained by having a sender electronically sign the data before sending it to the recipient. Sender verification can also be provided with a password, a smart card, a digital key, and/or biometric data provided by the sender and transmitted to the recipient. The recipient can use the verification provided by the sender as direct verification (e.g., a signature), or the recipient can use the verification to retrieve further data used for verification. For example, the recipient could use a password provided by the sender to retrieve and/or generate a signature key for the sender.

The conditions and options specified with the preferential formats 300 can also set device-processing instructions 310. The device-processing instructions 310 can specify how the data is to be processed or provided to the recipient when arriving at a destination device 130. For example, the device-processing instructions 310 can specify a particular location (e.g., a folder in an e-mail application, an output tray of a printing device, a table in a database, etc.) within one of the destination devices 130. The device-processing instructions 310 can also specify an appearance or format for the data once it is transmitted to a destination device 130, such as highlighting an email, printing a document in color, locking a file as read-only, and the like. The device-processing instructions 310 can also specify further routing instructions once the data is received at a destination device 130. For example, e-mail messages can be automatically forwarded to a specific address, data can be copied to multiple locations on a disk or in a database, and the like.

The device-processing instructions 310 can also include instructions for retrieving or “pulling” data with one of the destination devices 130. As described in detail below, data routed to a recipient can include indirect data that notifies or instructs a recipient of data for the recipient to retrieve. In some embodiments, the indirect data specifies how a recipient can manually retrieve the direct data identified by the indirect data. The device-processing instructions 310 can also, however, include instructions for automatically retrieving and processing the direct data identified by the indirect data routed to the recipient. The device-processing instructions 310 can also include instructions for retrieving and processing supplemental or additional data associated with the direct data.

The preferential formats 300 can also specify filtering instructions 312 that specify data to be rejected, blocked, and/or retained temporarily or permanently. For example, the filtering instructions 312 can specify data to be rejected, blocked, and/or retained based on the source or sender of the data or the content of the data.

The routing information 285 as described above relates to possible recipients of data. In some embodiments, however, the processor 250 can also be configured to obtain and transmit routing information 285 related to senders of data. Senders of data can include individuals operating the origination device 110 or the origination device 110 itself. In some embodiments, a sender of data can provide routing information 285 that includes preferential formats 300 specifying confirmation instructions 314. The confirmation instructions 314 can specify whether the sender requires transmission confirmation. Upon sending data, the sender may request a return message from the intended recipient indicating that the recipient received the data. A sender can require transmission confirmation for all sent data and/or can require transmission confirmation for data sent to a particular recipient or data containing particular content. For example, a sender may send important and confidential data to a particular recipient and may require transmission confirmation for any data sent to the recipient. The confirmation instructions 314 can also include instructions for retransmitting data if confirmation is not received within a particular time of transmitting the data and/or if a transmission confirmation is received by the sender that indicates an error or transmission failure. The confirmation instructions 314 can also specify a predetermined number of retransmission attempts to be performed by the origination device 110.

By requiring transmission confirmation, the sender becomes a recipient of data and can provide preferential formats 300 as described above specifying content conditions 304, formatting instructions 306, transmission instructions 308, device-processing instructions 310, and/or filtering instructions 312 related to how he or she wants the transmission confirmation routed. For example, a sender can specify that all transmission confirmations be routed to a voice mail address regardless of how the original data was sent (e.g., as an e-mail, as a fax, etc.).

As described above, after the processor 250 obtains and transmits the routing information 285 to the input/output module 270 on the bus 280, the input/output module 270 can transmit the routing information 285 to the destination server 120 on the connection 145. In some embodiments, the processor 250 also transmits the routing information 285 to the memory module 260 for storage. Storing the routing information 285 to the memory module 260 can allow the routing information 285 to be easily updated and modified as needed.

Returning to FIG. 3, the destination device 130 can include an input module 350. The input module 350 can be configured to receive data transmitted from the origination device 110. In some embodiments, the input module 350 can be connected to the input/output module 270 of the origination device 110 with the connection 140. As previously described, the input/output module 270 can transmit data to the input module 350. The input/output module 270 can also transmit processing instructions for the data. In some embodiments, the destination device 130 also includes a processor (not shown) configured to execute the processing instructions. The destination device 130 can further include an output module (not shown) configured to transmit data from the destination device 130 to the origination device 110 or another device. In some embodiments, the destination device 130 includes a processor configured to execute a transmission confirmation application and an output module configured to transmit a transmission confirmation to the origination device 110. It should be understood that the destination device 130 can include additional components such as a memory module, a printing mechanism, a faxing mechanism, and the like.

The destination server 120 can include a processor 400, a memory module 410, and an input/output module 420. The processor 400, the memory module 410, and the input/out module 420 can be connected with a bus 430.

In some embodiments, the processor 400 of the destination server 120 can be configured to fetch instructions and/or data from the memory module 410 via the bus 430. In some embodiments, the processor 400 is configured to fetch routing information stored in the memory module 410. The processor 400 can also fetch instructions for generating a routing application and can execute the instructions to generate a routing application based on the routing information. The processor 400 can also be configured to store and retrieve a routing application and/or routing information from the memory module 410 based on a recipient identifier.

The memory module 410 can include non-volatile memory such as one or more forms of ROM, one or more disk drives, RAM, other memory, or combinations of the foregoing. The memory module 410 can store routing information transmitted from the origination device 110. The memory module 410 can also store routing applications generated with the processor 400.

The input/output module 420 of the destination server 120 can transmit and receive data to and from the origination device 110. The input/output module 420 of the destination server 120 can be connected to the input/output module 270 of the origination device 110 with the connection 145. As previously described, the input/output module 270 of the origination device 110 can transmit routing information to the destination server 120. The input/output module 420 of the destination server 120 can receive the routing information and can provide the routing information to the processor 400. As previously described, the processor 400 can use the routing information to generate a routing application. The input/output module 420 can also store the routing information to the memory module 410.

Also previously described, the input/output module 270 of the origination device 110 can transmit a routing application request including a recipient identifier to the destination server 120. The input/output module 420 provides the recipient identifier to the processor 400 and may store the recipient identifier to the memory module 410. As previously described, the processor 400 uses the recipient identifier to retrieve a routing application from the memory module 410. The processor 400 can also use the recipient identifier to retrieve routing information from the memory module 410 and can generate a routing application based on the retrieved routing information.

The processor 400 can retrieve and/or generate a routing application based on a recipient identifier transmitted from the origination device 110, and the input/output module 420 of the destination server 120 can transmit the retrieved routing application to the origination device 110.

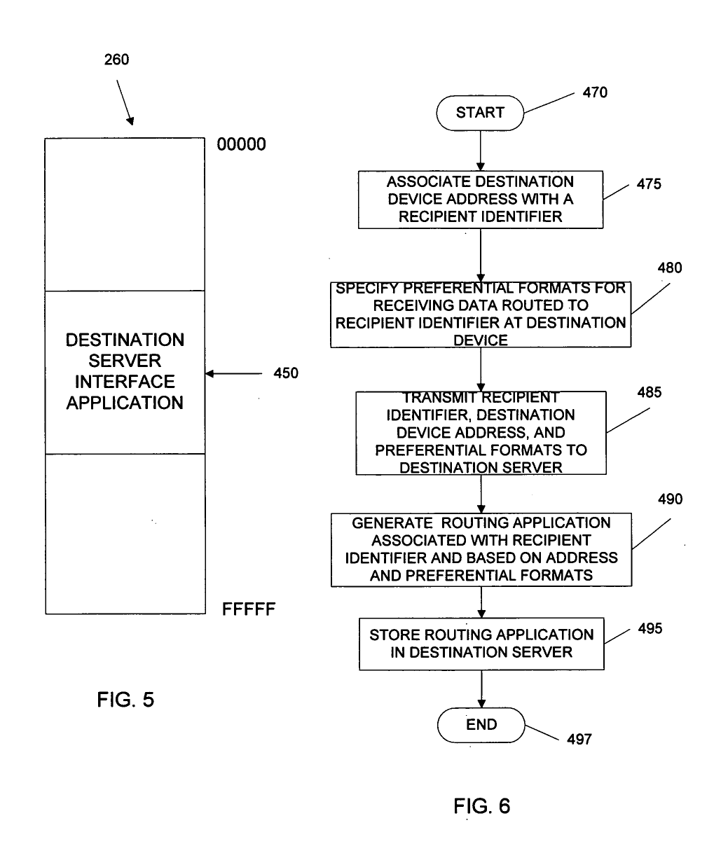

FIG. 5 represents a diagram of a portion of the memory module 260 of the origination device 110. As illustrated in FIG. 5, the memory module 260 can store a destination server interface application 450. The destination server interface application 450 can include instructions that, when executed with the processor 250, obtain information from a user of the origination device 110 and package information such that it can be transmitted to the destination server 120. In some embodiments, a user can specify data to be sent and/or a recipient identifier using the destination server interface application 450. The destination server interface application 450 can also be configured to obtain a sender identifier identifying the sender or source of the data to be routed. As previously described, the sender identifier may be used by the destination server 120 to determine if the sender requests transmission confirmation.

The destination server interface application 450 can be configured to generate a routing application request based on the selected recipient identifier and can transmit the request to the destination server 120 using the input/output module 270 of the origination device 110. The destination server interface application 450 can further be configured to receive a routing application transmitted from the destination server 120 in response to the request and to cause the routing application to be automatically executed with the origination device 110.

In some embodiments, the destination server interface application 450 can also be configured to obtain routing information and to transmit the routing information to the destination server 120. As previously defined, the routing information can include a recipient identifier, one or more addresses of destination devices 130, and preferential formats.

FIG. 6 illustrates an exemplary process of operating a destination server to generate a routing application. In some embodiments, the routing-application generation process illustrated in FIG. 6 is executed with one or more components of the data routing system 100. It should be understood that the process steps illustrated in FIG. 6 are exemplary in order and content, and the routing-application generation process can be accomplished with a subset of the depicted steps or additional and alternative steps.

As illustrated in FIG. 6, the process begins at start block 470. At block 475, a user creates an association between an address of a destination device 130 and a recipient identifier. The user can use the origination device 110 to associate an address with a recipient identifier. In some embodiments, the user associates a recipient identifier with one or more addresses. As previously described, a single address can include a group address that includes addresses of multiple destination devices.

At block 480, the user specifies preferential formats. As previously described, the preferential formats can specify conditions and options for routing data to the recipient identified by the recipient identifier. The preferential formats can include source conditions, content conditions, formatting instructions, transmission instructions, device-processing instructions, filtering instructions, and/or confirmation instructions, as described above. After associating the recipient identifier with the one or more destination device addresses and specifying preferential formats, the recipient identifier, the one or more destination device addresses, and the preferential formats are transmitted to the destination server 120 (block 485). As previously described, the destination server interface application 450, executed with a processing device operated by the user, may obtain and transmit the above elements.

Upon receiving the recipient identifier, the associated one or more destination device addresses, and the preferential formats, the destination server 120 generates a routing application at block 490. The routing application can be based on the associated destination device addresses and the preferential formats such that, when executed, the routing application causes data sent to the recipient to be routed to one of the destination device addresses as specified with the preferential formats. In some embodiments, the destination server 120 generates multiple routing applications based on the one or more addresses and the preferential formats. Each routing application, for example, can be configured to route data of different content, to route data to different destination devices 130, or the like. At block 495, the destination server 120 stores the generated routing application, and the routing application generation process is complete (end block 497). In some embodiments, the destination server 120 also stores the routing application to the memory module 410. In some embodiments, the destination server 120 stores or associates the recipient identifier with the generated routing application. By associating a recipient identifier with a generated routing application, the destination server 120 can retrieve a routing application upon receiving a request for a routing application including a particular recipient identifier. It should be understood that, alternatively, the destination server 120 can generate the routing application as needed or as requested. In some embodiments, the destination server 120 stores the recipient identifier, the one or more destination device addresses, and the preferential formats in addition to or in place of generating and storing a routing application. The destination server 120 can retrieve stored recipient identifiers, destination device addresses, and preferential formats to generate a routing application when the destination server 120 receives a routing application request from the origination device 110.

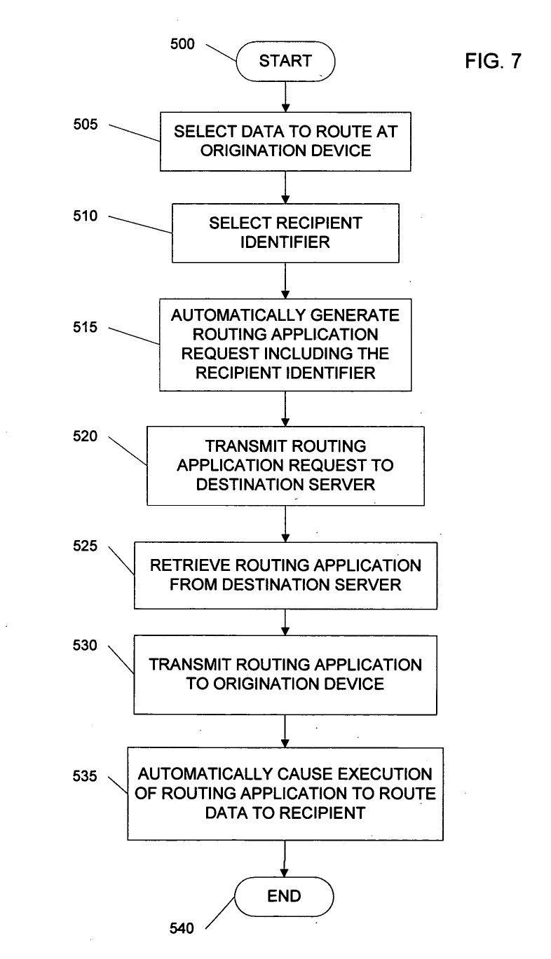

FIG. 7 illustrates an exemplary data routing process. In some embodiments, the data routing process illustrated in FIG. 7 is executed with one or more components of the data routing system 100. As noted, illustrated process steps are exemplary in order and content, and the data routing process can be accomplished with a subset of the depicted steps or additional and alternative steps.

The process begins at start block 500. At block 505, a user, using the origination device 110, selects data to be routed. In some embodiments, the data selected by the user includes the direct data to be routed or “pushed” to the recipient. It should be understood, however, that the data selected by the user can also include indirect data that notifies a recipient that direct data is available to be retrieved or “pulled” by the recipient. In some embodiments, data is stored in a document server where a recipient (or a destination device 130) can retrieve the data. When the data is stored in the document server and available for retrieval, indirect data can be routed to the intended recipient of the data that alerts the recipient to the availability of the stored data. In some embodiments, the indirect data can also specify a location or device from where the data can be retrieved. For example, the data selected by the user can include an address of a data repository (e.g., a document server) or a universal resource locator (“URL”) address referencing a web page or a file. The indirect data to be routed to a recipient can also instruct the recipient as how to manually retrieve the available data. Communicating via data “pulling” rather than data “pushing” has some benefits. Generally, data “pulling” can be accomplished with greater security since a recipient may be required to pass security checks to retrieve the data. For example, the data stored to the document server can be associated with a key or identifier that a recipient must provide in order to retrieve the data.

In some embodiments, the data selected by the user can also include direct data and indirect data identifying data associated with the direct data. For example, the sender may route “non-secure” data directly to the recipient and may also route indirect data to the recipient that specifies “secure” data to be retrieved by the recipient.

At block 510, the user selects a recipient identifier identifying an intended recipient of the previously selected data. The user can also select multiple recipient identifiers for the data if the data is to be routed to multiple recipients that are not identified by a single recipient identifier. As previously described, the destination server interface application 450 can obtain the selected data and/or the one or more recipient identifiers. In some embodiments, the destination server interface application 450 provides a graphical user interface for the user to select the data and/or the one or more recipient identifiers. The destination server interface application 450 can provide a drop-down list or other selection mechanism listing possible data and/or recipient identifiers. In some embodiments, the user can also use the destination server interface application 450 to select a sender identifier.

After the user has selected the data and the one or more recipient identifiers, the destination server interface application 450 generates a routing application request (block 515). In some embodiments, the routing application request includes the one or more recipient identifiers selected by the user. The routing application request can also include the data selected by the user. Furthermore, the routing application request can include a sender identifier. As previously described, a sender of data can provide preferential formats to the destination server 120 to specify whether the sender requests transmission confirmation of the sent data. The destination server 120 may use a sender identifier to determine a specific routing application to be returned to the origination device 110.

At block 520, the destination server interface application 450 transmits the routing application request to the destination server 120 over the connection 145. The destination server 120 receives the routing application request and retrieves a routing application. In some embodiments, the destination server 120 retrieves a routing application stored in the memory module 410. The destination server 120 can use the information included in the routing application request to determine a specific routing application to retrieve (block 525). In some embodiments, the destination server 120 uses the recipient identifier included in the routing application request to retrieve a specific routing application. The routing application retrieved can be a routing application previously generated when the recipient, identified by the recipient identifier, transmitted his or her routing information to the destination server 120 as described for FIG. 6.

If the request includes the data to be routed, the destination server 120 can use the content of the data to determine a specific routing application to retrieve. As previously described, the content of the data can be used to route the data, and the destination server 120 may have previously generated one or more routing applications configured to route specific data content.

In some embodiments, the destination server 120 can also use the sender identifier to retrieve a specific routing application. As described above, if the sender has requested transmission confirmation, the destination server 120 can retrieve a routing application that causes a confirmation message to be returned.

The destination server 120 can also retrieve an all-encompassing routing application that applies to any data including any content sent to any recipient. In some embodiments, the destination server 120 can generate an all-encompassing routing application from the routing information provided by all possible recipients and can retrieve the same routing application regardless of the information supplied in the routing application request.

The destination server 120 can also retrieve a routing application by retrieving specific routing information stored in the memory module 410 and generating a specific routing application when requested. In some embodiments, the routing information retrieved from the memory module 410 can include routing information previously provided to the destination server 120 by the recipient.

After the destination server 120 has retrieved a routing application, the destination server 120 transmits the routing application to the origination device 110 over the connection 145 (block 530). It should be understood that the routing application may not be an entire or complete application. In some embodiments, the destination server interface application 450 includes a base or main foundation of a routing application, and the destination server 120 transmits functions, classes, or code portions to complete the routing application.

Upon receiving the routing application from the destination server 120, the destination server interface application 450 causes the routing application to be automatically executed (block 535). As described above, the routing application transmitted from the destination server 120 can be executed as part of the destination server interface application 450. The routing application can also be a separate application from the destination server interface application 450, and the destination server interface application 450 can cause or direct the origination device 110 to load and execute the routing application transmitted from the destination server 120. Executing the routing application can cause the data selected by the user or sender to be routed to the recipient identified by the recipient identifier as specified by the routing information provided by the recipient. The routing application can set the address of the destination device 130 to which the data should be transmitted, can format the data such that the destination device 130 accepts the data, can analyze the data to determine data content, can encrypt the data, and can even reject the data. The routing application can also cause processing instructions or an application to be transmitted with the data. In some embodiments, the routing application can transmit formatting instructions to a destination device 130 or an intermediary device. The destination device 130 or intermediary device can execute the formatting instructions to further format the data when it is received. If the data is encrypted, the formatting instructions can include instructions for decrypting the data. As previously described, the formatting instructions executed with the destination device 130 can also inform a user of the destination device 130 of functions to be manually applied to the data.

In some embodiments, if the sender of the data requested transmission confirmation, the processing instructions can include an application to be executed with the destination device 130 to generate and transmit a transmission confirmation. The transmission confirmation can specify whether the data was successfully received. The transmission confirmation can also specify any errors that occurred. For example, the transmission confirmation can specify whether the data was received in a proper format, successfully decrypted, accepted or rejected, and the like. The formatting instructions, as described above, can also include instructions for displaying a message to a user of the destination device 130 to transmit a transmission confirmation to the sender of the data rather than transmitting processing instructions that automatically transmit a transmission confirmation.

After executing the routing application and transmitting the data and any accompanying processing instructions to the destination device 130, the destination device 130 receives the data, processes the data as instructed, and provides the data to the recipient. The data routing process then ends at block 540.

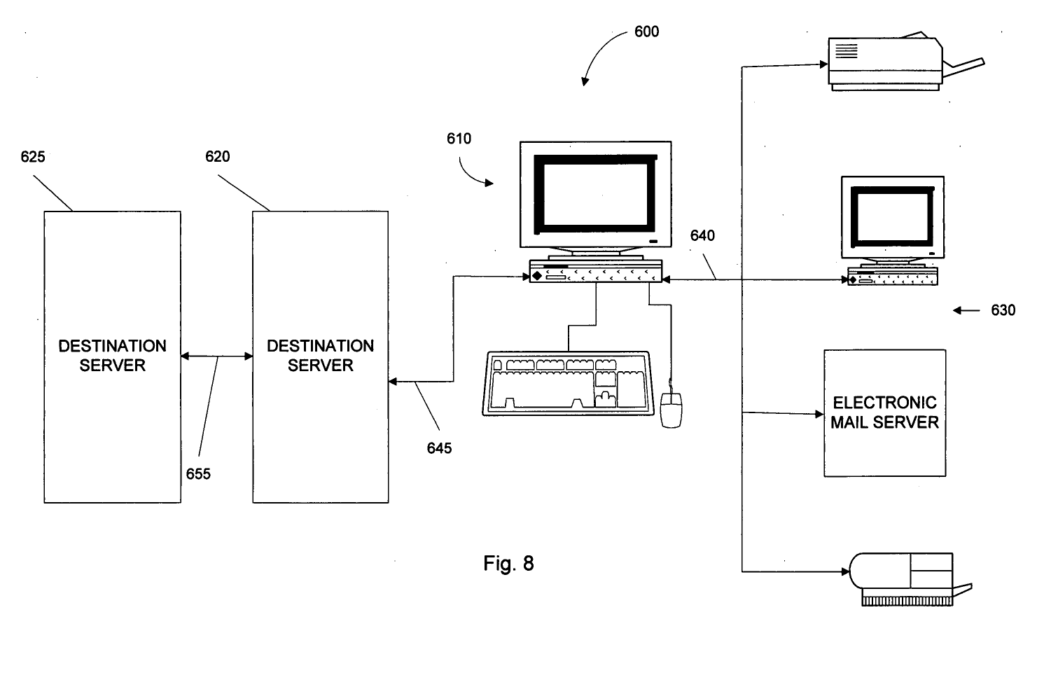

It should be understood that in some embodiments, a destination server can communicate with another destination server to obtain a routing application. As illustrated in FIG. 8, a data routing system 600 includes an origination device 610, a first destination server 620, a second destination server 625, and one or more destination devices 630. The origination device 610 can be connected to the one or more destination devices 630 with a connection 640. The origination device 610 can be connected to the first destination server 620 with a connection 645, and the first destination server 620 can be connected to the second destination server 625 with a connection 655. As described above, the origination device 610 can transmit a routing application request to the first destination server 620 over the connection 645. Depending on the recipient identifier, the data included in the request, and/or the sender of the request, the first destination server 620 can transmit another routing application request to the second destination server 625. The second destination server 625 can retrieve a routing application based on the routing application request received from the first destination server 620 and can transmit the routing application back to the first destination server 620. The first destination server 620 can then forward the routing application to the origination device 610. The first destination server 620 can also process the routing application received from the second destination before forwarding the routing application to the origination device 610. The second destination server 625 can also be connected to multiple destination servers. In some embodiments, a chain of destination servers can be connected to obtain a routing application.

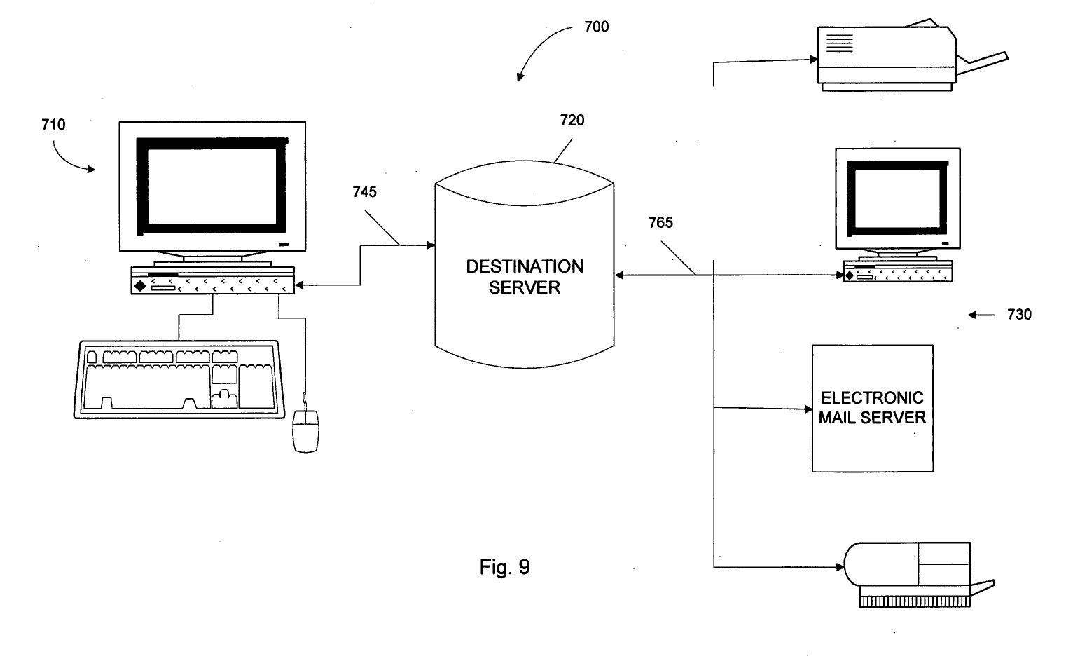

It should also be understood that a destination server can also be configured to execute a routing application. As illustrated in FIG. 9, a data routing system 700 can include an origination device 710, a destination server 720, and one or more destination devices 730. The origination device 710 can be connected to the destination server 720 via a connection 745, and the destination server 720 can be connected to the one or more destination devices 730 via a connection 765. The origination device 710 can transmit a routing application request to the destination server 720 over the connection 745. The routing application request can include a recipient identifier and data to be routed to a recipient identified with the recipient identifier. The routing application request can also include information identifying the sender.

The destination server 720 receives the routing application request and, as described above, can retrieve a routing application. Rather than transmitting the routing application back to the origination device 710, however, the destination server 720 can execute the routing application to route the data to one of the destination devices 730 over the connection 765. In some embodiments, the data arrives at one of the destination devices 730 and appears as if the data was directly transmitted from the origination device 710. The destination server can also be used to provide anonymous data routing such that the destination devices 730 cannot determine a specific origination device 710 that initiated the transmission.

In some embodiments, if a transmission confirmation was requested, the destination server 720 can also transmit a transmission confirmation to the origination device 710. The transmission confirmation can also be sent to one of the destination devices 730 and can be forwarded to the origination device 710 from the destination server 720. In some embodiments, the destination devices 730 can also transmit a transmission confirmation directly to the origination device 720.

Various features and advantages of the invention are set forth in the following claims.

1. A system for routing data over a network, the system comprising:
a destination device having an address; and
an origination device configured to generate a routing application request including a recipient identifier identifying a recipient of the data, to transmit the routing application request to a destination server, to receive a routing application from the destination server, and to automatically execute the routing application to route the data to the recipient by transmitting the data to the destination device,
wherein the destination server is configured to create the routing application based on the address of the destination device and preferential formats for routing data to the recipient, to receive the routing application request from the origination device, and to transmit the routing application to the origination device.

2. The system as claimed in claim 1, wherein the destination server is further configured to store the routing application.

3. The system as claimed in claim 2, wherein the destination server is further configured to retrieve the routing application based on the routing application request.

4. The system as claimed in claim 1, wherein the origination device includes a workstation.

5. The system as claimed in claim 1, wherein the destination device includes at least one of a printing device, a workstation, an electronic mail server, a facsimile device, a telephone, and a database.

6. The system as claimed in claim 1, wherein the destination server includes an application server.

7. The system as claimed in claim 1, wherein the origination device is further configured to transmit processing instructions to the destination device.

8. The system as claimed in claim 7, wherein the destination device is further configured to execute the processing instructions.

9. The system as claimed in claim 7, wherein the processing instructions include formatting instructions executable by the destination device to format the data.

10. The system as claimed in claim 7, wherein the processing instructions include an application executable by the destination device to transmit a transmission confirmation.

11. The system as claimed in claim 1, wherein the origination device is further configured to store the routing information.

12. The system as claimed in claim 1, wherein the destination server is further configured to transmit a second routing application request to a second destination server.

13. A method of routing data over a network, the method comprising:
selecting data to be routed with an origination device;
selecting a recipient identifier, the recipient identifier identifying a recipient of the data;
generating a routing application request including the recipient identifier;
transmitting the routing application request to a destination server;
retrieving a routing application from the destination server;
transmitting a routing application to the origination device from the destination server, wherein the routing application is associated with the recipient identifier; and
executing the routing application with the origination device to route the data to the recipient by transmitting the data to a destination device.

14. The method as claimed in claim 13, wherein selecting a recipient identifier includes selecting the recipient identifier from a listing of possible recipient identifiers.

15. The method as claimed in claim 13, wherein retrieving a routing application from the destination server is based on the recipient identifier.

16. The method as claimed in claim 13, further comprising transmitting a second routing application request to a second destination server.

17. The method as claimed in claim 16, further comprising transmitting a routing application to the destination server from the second destination server.

18. The method as claimed in claim 13, further comprising transmitting processing instructions to the destination device.

19. The method as claimed in claim 18, wherein the processing instructions include formatting instructions executable by the destination device to format the data.

20. The method as claimed in claim 18, wherein the processing instructions include an application executable by the destination device to transmit a transmission confirmation to the origination device.

21. The method as claimed in claim 13, further comprising executing processing instructions with the destination device.

22. A method of operating a destination server, the method comprising:
associating an address of a destination device with a recipient identifier, the recipient identifier identifying a recipient;
specifying preferential formats for routing data to the recipient with the destination device;
transmitting the recipient identifier, the address, and the preferential formats to the destination server;
generating a routing application associated with the recipient identifier based on the address and the preferential formats;
storing the routing application in the destination server; and
transmitting the routing application from the destination server to an origination device upon receiving a routing application request including the recipient identifier from the origination device.

23. The method as claimed in claim 22, wherein the preferential formats include source conditions.

24. The method as claimed in claim 22, wherein the preferential formats include content conditions.

25. The method as claimed in claim 22, wherein the preferential formats include formatting instructions.

26. The method as claimed in claim 22, wherein the preferential formats include transmission instructions.

27. The method as claimed in claim 22, wherein the preferential formats include device-processing instructions.

28. The method as claimed in claim 22, wherein the preferential formats include filtering instructions.

29. The method as claimed in claim 22, wherein the preferential formats include confirmation instructions.

30. The method as claimed in claim 22, further comprising storing the address and the preferential formats in the destination server.

31. The method as claimed in claim 22, further comprising associating the recipient identifier with the routing application.

32. A destination server comprising:
an input/output module configured to receive a routing application request including a recipient identifier from an origination device, to transmit a routing application to the origination device, and to receive an address of a destination device and preferential formats for routing data to a recipient identified by the recipient identifier with the destination device;
a memory module configured to store the routing application; and
a processor configured to generate the routing application based on the address and the preferential formats and to retrieve the routing application from the memory module upon receiving the routing application request from the origination device.

33. The destination server as claimed in claim 32, wherein the memory module is further configured to store the address and the preferential formats.

34. The destination server as claimed in claim 33, wherein the processor is further configured to retrieve the address and the preferential formats from the memory module.

35. The destination server as claimed in claim 32, wherein the input/output module is further configured to transmit a second routing application request to a second destination server.

36. The destination server as claimed in claim 35, wherein the input/output module is further configured to receive a routing application from the second destination server.

37. A destination server comprising:
an input/output module configured to receive a routing application request including data and a recipient identifier from an origination device, the recipient identifier identifying a recipient, to receive an address of a destination device and preferential formats for routing data to the recipient with the destination device, and to transmit the data to the destination device;
a memory module configured to store a routing application; and
a processor configured to generate the routing application based on the address and the preferential formats and to execute the routing application to route the data to the recipient.

38. The destination server as claimed in claim 37, wherein the memory module is further configured to store the address and the preferential formats.

39. The destination server as claimed in claim 38, wherein the processor is further configured to retrieve the address and the preferential formats from the memory module.

40. The destination server as claimed in claim 37, wherein the input/output module is further configured to transmit a second routing application request to a second destination server.

41. The destination server as claimed in claim 40, wherein the input/output module is further configured to receive a routing application from the second destination server.

42. A destination server interface application executable with an origination device to route data over a network, the application configured to obtain a recipient identifier, to generate a routing application request, to transmit the routing application request to a destination server, to receive a routing application from the destination server, and to cause the routing application to be executed.

43. The destination server interface application as claimed in claim 42, wherein the routing application request includes the recipient identifier.

44. The destination server interface application as claimed in claim 42, wherein the application is further configured to obtain a sender identifier.

45. The destination server interface application as claimed in claim 44, wherein the routing application request includes the sender identifier.

46. The destination server interface application as claimed in claim 42, wherein the application is further configured to obtain data to be routed to a recipient identified by the recipient identifier.

47. The destination server interface application as claimed in claim 46, wherein the routing application request includes the data.

48. A destination server interface application configured to obtain an address of a destination device and preferential formats for routing data to a recipient identified by a recipient identifier with the destination device and to transmit the recipient identifier, the address, and the preferential formats to a destination server.

49. The destination server interface application as claimed in claim 48, wherein the preferential formats include source conditions.

50. The destination server interface application as claimed in claim 48, wherein the preferential formats include content conditions.

51. The destination server interface application as claimed in claim 48, wherein the preferential formats include formatting instructions.

52. The destination server interface application as claimed in claim 48, wherein the preferential formats include transmission instructions.

53. The destination server interface application as claimed in claim 48, wherein the preferential formats include device-processing instructions.

54. The destination server interface application as claimed in claim 48, wherein the preferential formats include filtering instructions.

55. The destination server interface application as claimed in claim 48, wherein the preferential formats include confirmation instructions.

56. A computer-readable medium including instructions for operating a destination server, the computer-readable medium comprising instructions for:
associating an address of a destination device with a recipient identifier, the recipient identifier identifying a recipient;
specifying preferential formats for routing data to the recipient with the destination device;
transmitting the recipient identifier, the address, and the preferential formats to the destination server;
generating a routing application associated with the recipient identifier based on the address and the preferential formats;
storing the routing application in the destination server; and
transmitting the routing application to an origination device upon receiving a routing application request including the recipient identifier.

57. The computer-readable medium as claimed in claim 56, wherein the preferential formats include source conditions.

58. The computer-readable medium as claimed in claim 56, wherein the preferential formats include content conditions.

59. The computer-readable medium as claimed in claim 56, wherein the preferential formats include formatting instructions.

60. The computer-readable medium as claimed in claim 56, wherein the preferential formats include transmission instructions.

61. The computer-readable medium as claimed in claim 56, wherein the preferential formats include device-processing instructions.

62. The computer-readable medium as claimed in claim 56, wherein the preferential formats include filtering instructions.

63. The computer-readable medium as claimed in claim 56, wherein the preferential formats include confirmation instructions.

64. The computer-readable medium as claimed in claim 56, further comprising instructions for storing the address and the preferential formats in the destination server.

65. The computer-readable medium as claimed in claim 56, further comprising instructions for associating the recipient identifier with the routing application.
